(19) United States
(12) Patent Application Publication
(10) Pub. No.: US 2026/0169361 A1
(43) Pub. Date: Jun. 18, 2026

(54) MULTI-CAMERA RIGS

(71) Applicants: Sony Group Corporation, Tokyo (JP); Sony Pictures Entertainment Inc., Culver City, CA (US)

(72) Inventors: Bryan Howard, Burlington (CA); Matej Kosovsky, Toronto (CA); Nikola Dordic, Vancouver (CA); Mahmoud Rahnama, Toronto (CA)

(21) Appl. No.: 19/189,095

(22) Filed: Apr. 24, 2025

Related U.S. Application Data
(60) Provisional application No. 63/734,575, filed on Dec. 16, 2024.

(51) Int. Cl. G03B 17/56

(52) U.S. Cl. CPC G03B 17/561

(57) ABSTRACT

A multi-camera rig apparatus including: a central ring including a plurality of couplers spaced about the central ring; a plurality of rails and modular attachments, each rail and modular attachment coupled to each of the plurality of couplers; a moon ring assembly coupled to each rail and modular attachment, the moon ring assembly including a semi-circular rail and an indexing mechanism configured to receive a spring-loaded steel ball; and a camera plate including a first mounting surface and a second mounting surface, the first mounting surface attached to the moon ring assembly and the second mounting surface configured for mounting to a camera.

### CROSS-REFERENCE TO RELATED APPLICATIONS

This application claims the benefit of priority under 35 U.S.C. § 119(e) of co-pending U.S. Provisional Patent Application No. 63/734,575, filed Dec. 16, 2024, entitled “TORI Rig”. The disclosure of the above-referenced application is incorporated herein by reference.

### BACKGROUND

### Field

The present disclosure relates to multi-camera rigs, and more specifically to a multi-camera rig designed to optimize camera pitch adjustments around the physical sensor axis.

### Background

Prior methods for achieving camera pitch adjustments in multi camera rigs often involved setups including the use of hinged joints positioned either at the top, bottom, or sides of the camera. These setups may have limitations including having rigidity issues, space constraints, inconsistent sensor alignment, and being complex and bulky.

Regarding lack of rigidity, hinges mounted on the top or bottom of the camera may introduce leverage effects, which significantly reduce the overall stability of the rig. This is especially problematic in systems requiring precise alignment, as even minor flexing can lead to misalignment. Regarding space constraints, side-mounted hinges may be unsuitable for radial camera setups due to the confined space between cameras. These configurations prevent full motion and often require additional clearance, making them impractical for compact multi-camera arrays. Regarding issues with complexity and bulk, traditional hinge designs often involve more components, increasing the weight and assembly complexity of a camera rig. Regarding inconsistent sensor alignment, many existing systems fail to align the pitch rotation axis with the physical sensor, resulting in undesirable shifts in image geometry during adjustments.

### SUMMARY

The present disclosure provides for a multi-camera rig designed to optimize camera pitch adjustments around the physical sensor axis.

In one implementation, a multi-camera rig apparatus is disclosed. The apparatus includes: a central ring including a plurality of couplers spaced about the central ring; a plurality of rails and modular attachments, each rail and modular attachment coupled to each of the plurality of couplers; a moon ring assembly coupled to each rail and modular attachment, the moon ring assembly including a semi-circular rail and an indexing mechanism configured to receive a spring-loaded steel ball; and a camera plate including a first mounting surface and a second mounting surface, the first mounting surface attached to the moon ring assembly and the second mounting surface configured for mounting to a camera.

In another implementation, a method for attaching multiple cameras into a rig and providing a precise pitch movement for a camera is disclosed. The method includes: providing means for attaching multiple cameras into a circularly-shaped configuration at equally-spaced positions about a center of the circularly-shaped configuration; attaching a rail and modular attachment to each position of the equally-spaced positions; coupling a moon ring assembly to the rail and modular attachment, wherein the moon ring assembly includes a semi-circular rail and an indexing mechanism configured to receive a spring-loaded steel ball; and attaching a camera plate to the moon ring assembly, wherein the camera plate is configured to receive the camera.

Other features and advantages should be apparent from the present description which illustrates, by way of example, aspects of the disclosure.

### BRIEF DESCRIPTION OF THE DRAWINGS

The details of the present disclosure, both as to its structure and operation, may be gleaned in part by study of the appended drawings, in which like reference numerals refer to like parts, and in which:

FIG. 1 is a multi-camera rig in accordance with one implementation of the present disclosure;

FIG. 2 is a side view of the multi-camera rig in accordance with one implementation of the present disclosure;

FIG. 3 is a top view of the multi-camera rig along cross-section 2-2 of FIG. 2 in accordance with one implementation of the present disclosure;

FIGS. 4A and 4B are detailed top views of the rail and modular attachment and the coupler shown in cross-section 3-3 of FIG. 3 in accordance with one implementation of the present disclosure;

FIG. 5 is a front view of the camera plate in accordance with one implementation of the present disclosure;

FIG. 6 is a side view (shown along cross-section 5-5 of FIG. 5) of the camera plate attached to the moon ring assembly in accordance with one implementation of the present disclosure;

FIG. 7 is a detailed side view of the indexing mechanism shown in cross-section 6-6 of FIG. 6 in accordance with one implementation of the present disclosure;

FIG. 8 is a side perspective view of the rail and modular attachment and the indexing mechanism in accordance with one implementation of the present disclosure;

FIG. 9 is an exploded view of the rail and modular attachment including the spring-loaded steel ball in accordance with one implementation of the present disclosure; and

FIG. 10 is a flow diagram illustrating a method for attaching multiple cameras into a rig and providing a precise pitch movement for the cameras in accordance with one implementation of the present disclosure.

### DETAILED DESCRIPTION

As described above, prior methods for achieving camera pitch adjustments in multicamera rigs often involved setups which may have limitations including having rigidity issues, space constraints, inconsistent sensor alignment, and being complex and bulky. Accordingly, these limitations highlight the need for a more efficient, rigid, and compact design that aligns the rotation axis precisely with the camera's sensor.

Certain implementations of the present disclosure provide for a robust, space efficient, and precise multi-camera rig designed to optimize camera pitch adjustments around the physical sensor axis. This multi-camera rig ensures rigidity and adaptability in radial camera setups by utilizing a minimal number of components. The rig also enables accurate and repeatable angle adjustments with incremental indexing. After reading below descriptions, it will become apparent how to implement the disclosure in various implementations and applications. Although various implementations of the present disclosure will be described herein, it is understood that these implementations are presented by way of example only, and not limitation. As such, the detailed description of various implementations should not be construed to limit the scope or breadth of the present disclosure.

Implementations of the physical structure of the multi-camera rig include one or more of the following key components: (1) a moon ring assembly including (a) a semi-circular rail and (b) circular indexing pockets; (2) a camera plate including a rigid aluminum plate attached to both ends of the moon ring assembly; (3) rail and modular attachment including a NATO-compatible rail; (4) An indexing mechanism; (5) a central ring to attach the camera rigs; and (6) fastening hardware.

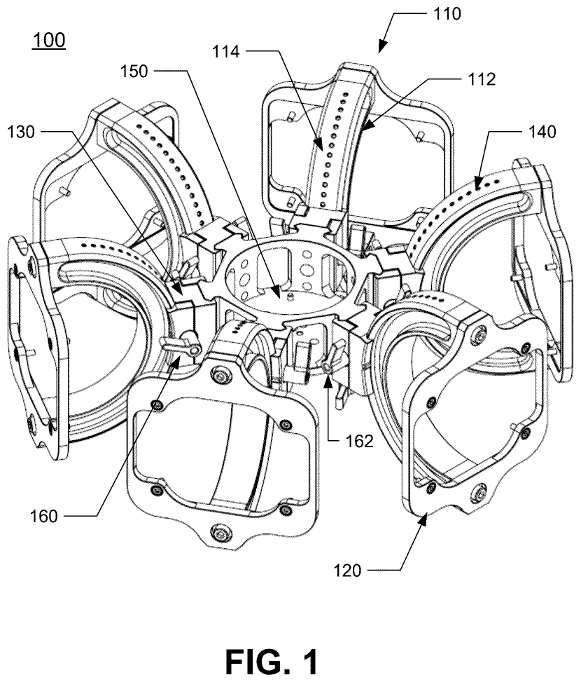

FIG. 1 is a multi-camera rig 100 in accordance with one implementation of the present disclosure. In the illustrated implementation of FIG. 1, the multi-camera rig 100 includes a moon ring assembly 110, a camera plate 120, a rail and modular attachment 130, an indexing mechanism 140, a central ring 150, and fastening hardware 160.

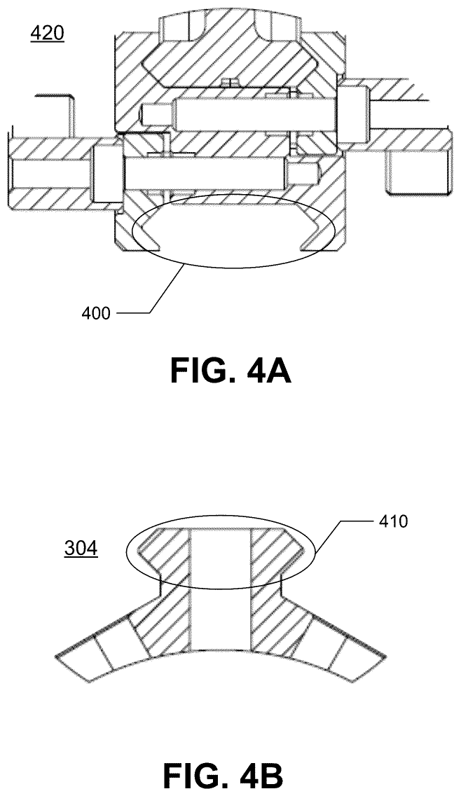

In one implementation, the rail and modular attachment 130 includes two separate modular parts (i.e., a rail part and a modular attachment assembly part)for easy addition and removal. For example, in one implementation, the modular attachment assembly part facilitates attaching the moon ring assembly 110 (which includes a unique curved NATO rail) to the central ring 150 (which incorporates linear NATO rails). In one implementation, the modular attachment assembly part also acts as a clamping mechanism between the two differing rails (i.e., the curved NATO rail of the moon ring assembly 110 and linear NATO rail of the central ring 150). The functional details of the modular attachment assembly part is further described below with respect to FIGS. 3, 4A, and 4B.

In one implementation, the moon ring assembly 110 includes a semi-circular rail 112 and circular indexing pockets 114. In one implementation, the semi-circular rail 112 is made from computer numerical control machined (CNC-machined) aluminum. In one implementation, the aluminum is black anodized for durability and laser-etched with angle markings for precision. In one implementation, the circular indexing pockets 114 are designed to be spaced at 5-degree intervals to interface with a spring-loaded steel ball for secure and repeatable angle adjustments.

In one implementation, the camera plate 120 acts as a plate onto which a camera is mounted. In one implementation, the camera plate 120 is a rigid aluminum plate attached to both ends of the moon ring assembly 110. In one implementation, the camera plate 120 serves a dual purpose of mounting the camera securely and acting as a structural member to enhance the rigidity of the moon ring assembly, particularly at extreme pitch angles. In one implementation, the camera plate 120 features a standardized mounting interface tailored to the specific camera model, ensuring alignment of the rotation axis with the camera sensor.

In one implementation, the rail and modular attachment 130 is designed as linear NATO-compatible rails and are integrated into the rig to facilitate the attachment of modular components. In one implementation, the design enables easy customization and expansion of the rig for additional equipment or accessories. In one implementation, the NATO-compatible rails are designed as NATO-profile rails to constrain sliding mechanisms and to ensure smooth pitch rotation.

In one implementation, the indexing mechanism 140 includes circular pockets on the moon ring assembly 110 and receives a spring-loaded steel ball. In one implementation, the indexing mechanism 140 provides tactile feedback and secure locking for each incremental adjustment.

In one implementation, the fastening hardware 160 includes high-strength quick release adjustable thumb knobs and locking mechanisms 162 (which turn by hand to tighten/loosen) to connect the camera plate and the moon ring assembly, which ensures stability and ease of assembly without using any tools. In one implementation, the fastening hardware 160 is a compact and highly modular structure which provides a strong, precise, and adaptable foundation for the multi-camera rig 100, addressing the challenges of traditional hinge-based designs.

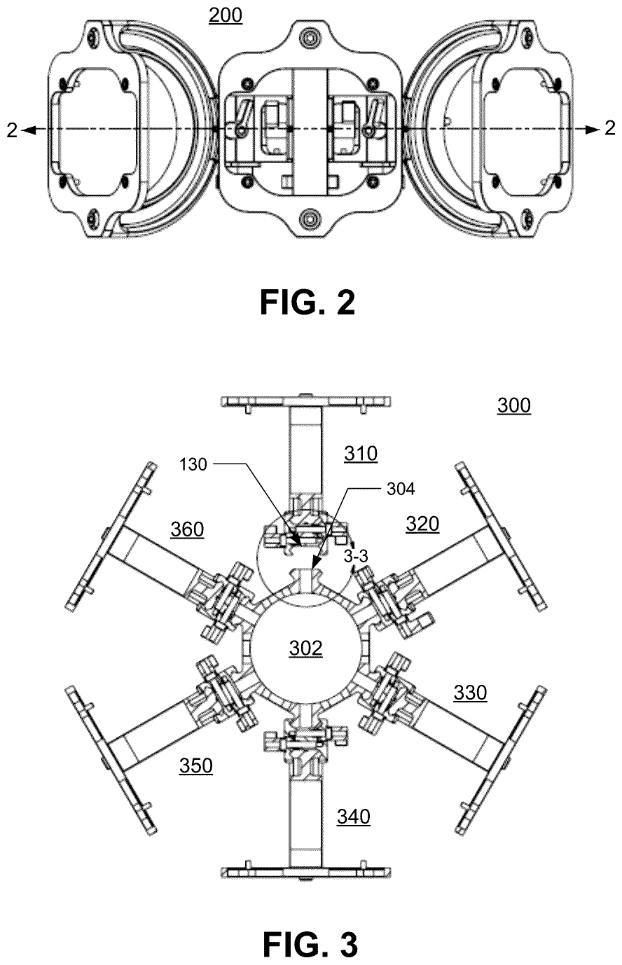

FIG. 2 is a side view 200 of the multi-camera rig 100 in accordance with one implementation of the present disclosure.

FIG. 3 is a top view 300 of the multi-camera rig 100 along cross-section 2-2 of FIG. 2 in accordance with one implementation of the present disclosure. The illustrated implementation of FIG. 3 shows the multi-camera rig 100 including six camera rigs 310-360 positioned 60 degrees apart. This configuration is shown only as an example and may be adjusted to different configurations. The camera rigs 320-360 are shown as attached to the central ring 302, while the camera rig 310 is shown as detached to illustrate how the rail and modular attachment 130 is used to attach the camera rig 310 to a coupler 304 of the central ring 302.

FIGS. 4A and 4B are detailed top views of a modular attachment assembly part 420 of the rail and modular attachment 130 and the coupler 304 shown in cross-section 3-3 of FIG. 3 in accordance with one implementation of the present disclosure. It should be noted that the modular attachment assembly part 420 shown in FIG. 4A is attached to the moon ring assembly 110, while the coupler 304 shown in FIG. 4B is attached to the central ring 302 of the multi-camera rig 100. Thus, the camera rig 310 may be attached to the central ring 302 by inserting an opening 400 of the modular attachment assembly part 420 into a protrusion 410 of the coupler 304.

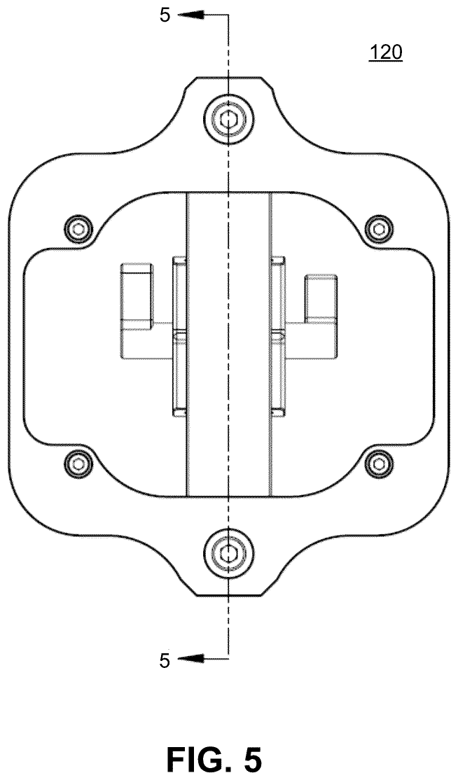

FIG. 5 is a front view of the camera plate 120 in accordance with one implementation of the present disclosure.

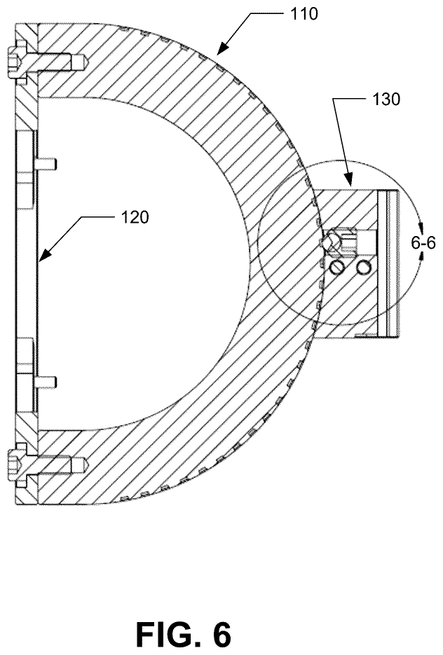

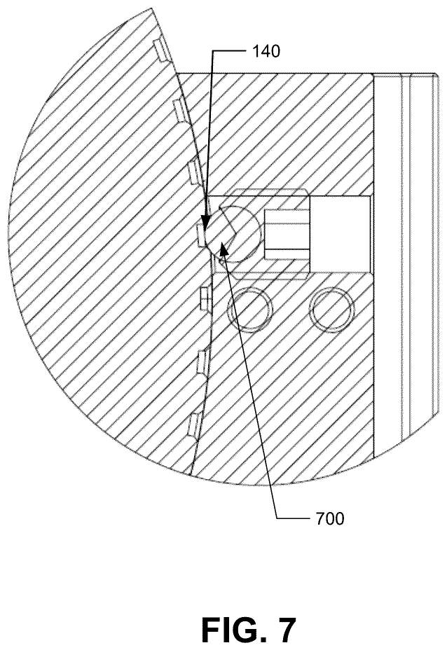

FIG. 6 is a side view (shown along cross-section 5-5 of FIG. 5) of the camera plate 120 attached to the moon ring assembly 110 in accordance with one implementation of the present disclosure. FIG. 6 also shows the rail and modular attachment 130 attached to the moon ring assembly 110.

FIG. 7 is a detailed side view of the indexing mechanism 140 shown in cross-section 6-6 of FIG. 6 in accordance with one implementation of the present disclosure. FIG. 7 also shows the spring-loaded steel ball 700 being inserted into the indexing mechanism 140.

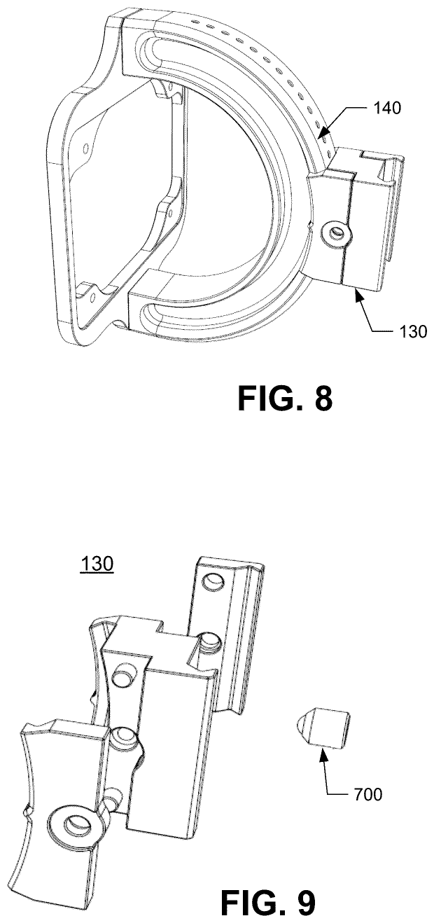

FIG. 8 is a side perspective view of the rail and modular attachment 130 and the indexing mechanism 140 in accordance with one implementation of the present disclosure.

FIG. 9 is an exploded view of the rail and modular attachment 130 including the spring-loaded steel ball 700 in accordance with one implementation of the present disclosure.

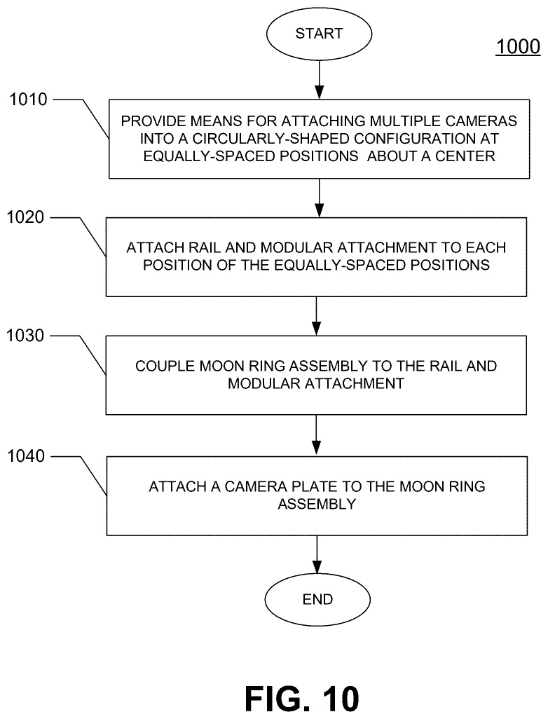

FIG. 10 is a flow diagram illustrating a method 1000 for attaching multiple cameras into a rig and providing a precise pitch movement for the cameras in accordance with one implementation of the present disclosure.

In the illustrated implementation of FIG. 10, the method 1000 includes providing means for attaching multiple cameras into a circularly-shaped configuration at equally-spaced positions about a center of the circularly-shaped configuration, at step 1010. A rail and modular attachment is attached, at step 1020, to each position of the equally-spaced positions. A moon ring assembly is coupled to the rail and modular attachment, at step 1030. In one implementation, the moon ring assembly includes a semi-circular rail and an indexing mechanism configured to receive a spring-loaded steel ball. A camera plate is then attached, at step 1040, to the moon ring assembly, wherein the camera plate is configured to receive the camera.

In one implementation, the multi-camera rig 100 operates by allowing controlled pitch adjustments of the camera in a radial multi-camera setup. The attachments move along a curved NATO-compatible rail referred to as the moon ring assembly, which holds the camera plate that is attached to the camera. The curved NATO-compatible rail constrains the motion, ensuring that the camera plate slides smoothly for accurate pitch adjustment.

In one implementation, the pitch is adjusted by sliding the camera plate along the rail, with the indexing mechanism (comprising a spring-loaded steel ball and circular pockets) allowing the user to stop at 5-degree increments. The quick-release screw locks the curved rail in place once the desired pitch angle is set, preventing any unwanted movement.

In one implementation, the function of the multi-camera rig 100 is to enable precise, repeatable, and stable pitch adjustments for cameras in radial configurations. The design ensures that the camera's pitch axis aligns with the physical sensor, offering an adjustable, robust solution for multi-camera setups. By incorporating the curved rail moon ring and indexing mechanism, the rig provides smooth, incremental adjustments to the pitch, with a secure locking mechanism for added stability. Accordingly, the above-described implementations substantially reduce common issues with conventional systems, such as leverage and misalignment, making it ideal for applications requiring high prec1s1on.

The multi-camera rig 100 may be used primarily in professional environments where multiple cameras are needed to be adjusted to specific angles, such as in cinematography, photogrammetry, or scientific research. Further, the indexing mechanism and quick-release screw/ball ensure ease of use, making it suitable for setups that require rapid adjustments without sacrificing accuracy.

In alternative implementations, methods, materials, or apparatus that can achieve similar results as the multi-camera rig include:

### 1) Hinged Joint Mechanism

An alternative to the moon ring assembly for pitch adjustment may be to use a hinged joint mechanism mounted either on the bottom or the sides of the camera.

### 2) Ball-and-Socket Joint Mechanism

Another alternative includes using a ball-and-socket joint for the camera's pitch adjustment.

### 3) Alternative Materials

While the multi-camera rig 100, in one implementation, is made from CNC-machined aluminum with a black anodized finish, other materials may be considered. For example, steel may provide increased strength and rigidity. For example, carbon fiber may be used for a lighter alternative to aluminum, providing a strong, lightweight design. In another example, using lightweight plastic or composite materials for certain parts may reduce costs and weight.

In a particular implementation, a multi-camera rig apparatus is disclosed. The apparatus includes: a central ring including a plurality of couplers spaced about the central ring; a plurality of rails and modular attachments, each rail and modular attachment coupled to each of the plurality of couplers; a moon ring assembly coupled to each rail and modular attachment, the moon ring assembly including a semi-circular rail and an indexing mechanism configured to receive a spring-loaded steel ball; and a camera plate including a first mounting surface and a second mounting surface, the first mounting surface attached to the moon ring assembly and the second mounting surface configured for mounting to a camera.

In one implementation, the semi-circular rail is made from computer numerical control machined (CNC-machined) aluminum. In one implementation, the aluminum is black anodized and laser-etched with angle markings. In one implementation, the indexing mechanism includes circular indexing pockets designed to be spaced at 5-degree intervals to interface with the spring-loaded steel ball. In one implementation, the moon ring assembly includes top and bottom ends. In one implementation, the camera plate is a rigid aluminum plate attached to the top and bottom ends of the moon ring assembly. In one implementation, the camera plate includes a standardized mounting interface tailored to a specific camera model. In one implementation, the plurality of rails and modular attachments includes linear NATO-compatible rails designed to constrain sliding mechanisms and to ensure smooth pitch rotation. In one implementation, the indexing mechanism provides tactile feedback and secure locking for each incremental adjustment. In one implementation, the apparatus further includes a fastening hardware including high-strength quick release thumb bolts and locking mechanisms to connect the camera plate and the moon ring assembly.

In another particular implementation, a method for attaching multiple cameras into a rig and providing a precise pitch movement for a camera is disclosed. The method includes: providing means for attaching multiple cameras into a circularly-shaped configuration at equally-spaced positions about a center of the circularly-shaped configuration; attaching a rail and modular attachment to each position of the equally-spaced positions; coupling a moon ring assembly to the rail and modular attachment, wherein the moon ring assembly includes a semi-circular rail and an indexing mechanism configured to receive a spring-loaded steel ball; and attaching a camera plate to the moon ring assembly, wherein the camera plate is configured to receive the camera.

In one implementation, the semi-circular rail is made from computer numerical control machined (CNC-machined) aluminum. In one implementation, the aluminum is black anodized and laser-etched with angle markings. In one implementation, the indexing mechanism includes circular indexing pockets spaced at 5-degree intervals to interface with the spring-loaded steel ball. In one implementation, the method further includes attaching the camera plate to top and bottom ends of the moon ring assembly. In one implementation, the indexing mechanism provides tactile feedback and secure locking for each incremental adjustment. In one implementation, the method further includes providing a fastening hardware including high-strength quick release thumb bolts and locking mechanisms to connect the camera plate and the moon ring assembly.

The description herein of the disclosed implementations is provided to enable any person skilled in the art to make or use the present disclosure. Numerous modifications to these implementations would be readily apparent to those skilled in the art, and the principals defined herein can be applied to other implementations without departing from the spirit or scope of the present disclosure. Thus, the present disclosure is not intended to be limited to the implementations shown herein but is to be accorded the widest scope consistent with the principal and novel features disclosed herein.

All features of each above-discussed example are not necessarily required in a particular implementation of the present disclosure. Further, it is to be understood that the description and drawings presented herein are representative of the subject matter that is broadly contemplated by the present disclosure. It is further understood that the scope of the present disclosure fully encompasses other implementations that may become obvious to those skilled in the art and that the scope of the present disclosure is accordingly limited by nothing other than the appended claims.

1. A multi-camera rig apparatus, comprising:
a central ring including a plurality of couplers spaced about the central ring;
a plurality of rails and modular attachments, each rail and modular attachment coupled to each of the plurality of couplers;
a moon ring assembly coupled to each rail and modular attachment,
the moon ring assembly including a semi-circular rail and an indexing mechanism configured to receive a spring-loaded steel ball; and
a camera plate including a first mounting surface and a second mounting surface, the first mounting surface attached to the moon ring assembly and the second mounting surface configured for mounting to a camera.

2. The apparatus of claim 1, wherein the semi-circular rail is made from computer numerical control machined (CNC-machined) aluminum.

3. The apparatus of claim 2, wherein the aluminum is black anodized and laser-etched with angle markings.

4. The apparatus of claim 1, wherein the indexing mechanism includes circular indexing pockets designed to be spaced at 5-degree intervals to interface with the spring-loaded steel ball.

5. The apparatus of claim 1, wherein the moon ring assembly includes top and bottom ends.

6. The apparatus of claim 5, wherein the camera plate is a rigid aluminum plate attached to the top and bottom ends of the moon ring assembly.

7. The apparatus of claim 1, wherein the camera plate includes a standardized mounting interface tailored to a specific camera model.

8. The apparatus of claim 1, wherein the plurality of rails and modular attachments includes linear NATO-compatible rails designed to constrain sliding mechanisms and to ensure smooth pitch rotation.

9. The apparatus of claim 1, wherein the indexing mechanism provides tactile feedback and secure locking for each incremental adjustment.

10. The apparatus of claim 1, further comprising
a fastening hardware including high-strength quick release thumb bolts and locking mechanisms to connect the camera plate and the moon ring assembly.

11. A method for attaching multiple cameras into a rig and providing a precise pitch movement for a camera, the method comprising:
providing means for attaching multiple cameras into a circularly-shaped configuration at equally-spaced positions about a center of the circularly-shaped configuration;
attaching a rail and modular attachment to each position of the equally-spaced positions;
coupling a moon ring assembly to the rail and modular attachment,
wherein the moon ring assembly includes a semi-circular rail and an indexing mechanism configured to receive a spring-loaded steel ball; and
attaching a camera plate to the moon ring assembly,
wherein the camera plate is configured to receive the camera.

12. The method of claim 11, wherein the semi-circular rail is made from computer numerical control machined (CNC-machined) aluminum.

13. The method of claim 12, wherein the aluminum is black anodized and laser-etched with angle markings.

14. The method of claim 11, wherein the indexing mechanism includes circular indexing pockets spaced at 5-degree intervals to interface with the spring-loaded steel ball.

15. The method of claim 11, further comprising attaching the camera plate to top and bottom ends of the moon ring assembly.

16. The method of claim 11, wherein the indexing mechanism provides tactile feedback and secure locking for each incremental adjustment.

17. The method of claim 11, further comprising
providing a fastening hardware including high-strength quick release thumb bolts and locking mechanisms to connect the camera plate and the moon ring assembly.
